(19) United States
(12) Patent Application Publication
(10) Pub. No.: US 2009/0293286 A1
(43) Pub. Date: Dec. 3, 2009

(54) Levered blade actuator

(76) Inventor: James Lee Williams, Texas City, TX (US)

Correspondence Address: WILLIAM P. GLENN, JR.;ROYSTON, RAYZOR, VICKERY & WILLIAMS, L.L.P., 2102 MECHANIC STREET, SUITE 205, GALVESTON, TX, 77550, US

(21) Appl. No.: 12/455,064

(22) Filed: May 28, 2009

Related U.S. Application Data
(63) Continuation-in-part of application No. 12/290,712, filed on Nov. 3, 2008.
(60) Provisional application No. 61/130,272, filed on May 29, 2008.

(51) Int. Cl. B26B 3/06

(52) U.S. Cl. 30/158

(57) ABSTRACT

A levered actuator in a knife controls movement of the blade from a closed position to an open position. The knife includes a blade having a tang pivotally coupled to a knife handle or a liner within the knife handle. The blade is operatively coupled to a levered actuator by a blade pin which rides in a groove formed in the handle or liner and an actuator groove formed in the actuator. A digit tab extends away from the knife handle for operation of the actuator. The pivoting actuator moves the blade by moving the blade pin.

### CROSS REFERENCE

This application is a continuation-in-part of U.S. patent application Ser. No. 12/290,712, filed Nov. 3, 2008 entitled Levered Blade Actuator, the disclosure of which is herein incorporated by reference. This application, in turn, may claim the benefit of and priority from one or more of the following U.S. Provisional Patent Applications, the disclosures of which are herein incorporated by reference: Ser. No. 61/001,365 filed Nov. 1, 2007 entitled Levered Blade Actuator; and Ser. No. 61/130,272 filed May 29, 2008 entitled Levered Blade Actuator.

### BACKGROUND

1. Technical Field

Generally, this invention relates to cutlery, multitool or any folding implement that folds or otherwise retracts into the handle to protect the implement, such as a blade, for example, while not in use. Specifically, this invention relates to implements in which a means is provided for positively moving the blade from the handle towards an open position.

2. Description of the Related Art

In the cutlery industry, a folding knife includes a housing or handle to support the blade in the open position and for receiving the blade in the closed position. Challenges lie in starting the movement of a knife blade. Controlling movement of a pivoting knife blade is generally known and examples of such control can be found in Collins U.S. Pat. No. 5,815,927, Glesser U.S. Pat. No. 6,918,184, Leatherman's flipper knife models E306x and E307x, Onion U.S. Pat. Nos. 6,591,504, and 6,145,202, and Onion U.S. Patent Application Publication 2005/0132576.

The actuator and stop mechanism of the present invention overcomes various deficiencies of folding knives and opening and closing mechanisms presently known in the knife and cutlery industry by providing positive opening assistance while enabling such opening to be performed with only a single hand of the user.

### BRIEF SUMMARY

This invention generally provides for a folding knife mechanism comprising a blade, a handle for receiving and supporting the blade and a lever operated blade actuator that provides positive assistance for opening the blade.

In each of the embodiments described herein, a cavity is formed in the handle to substantially receive the blade in the closed position and the blade actuator is pivotally coupled to the handle. The blade actuator is linked to the blade by a blade pin extending from the blade's tang through an actuator groove formed in the blade actuator. Force is applied to a digit tab at an end of the blade actuator which in turn, through the linkage of the actuator groove and blade pin causes the blade to pivot from a closed position within the handle to an open or extended position in which the blade is deployed for use.

In one embodiment, the actuator is pivotally coupled at one end to the handle, the actuator groove is formed in the midsection of the actuator and the digit tab is located at the other end of the actuator. The handle further includes at least one liner adjacent to the cavity and the blade pin extends through a primary groove formed in at least one liner and further through the actuator groove.

In another embodiment of the invention, the actuator and digit tab are pivotally coupled at one end to the handle and the actuator groove is formed in the other end of the actuator. The handle further includes at least one liner adjacent to the cavity and the blade pin extends through a primary groove formed in at least one liner and further through the actuator groove. An actuator pin extends from the digit tab through a secondary groove formed in the handle.

In yet another embodiment of the invention, the actuator is pivotally coupled at one end to the handle and the actuator groove is formed in the other end of the actuator. The digit tab is slideably linked to an actuator groove formed in the midsection of the actuator by an actuator pin extending from the digit tab through a secondary groove formed in at least one liner.

In still yet another embodiment of the invention, the actuator is pivotally coupled to the handle in the midsection of the actuator, the actuator groove is formed in one end of the actuator and the digit tab is located at the other end of the actuator. The handle further includes at least one liner adjacent to the cavity and the blade pin extends through a primary groove formed in at least one liner and further through the actuator groove.

### BRIEF DESCRIPTION OF DRAWINGS

FIG. 1 depicts a profile view of one embodiment of the present invention with the blade in an open position.

FIG. 2 depicts a profile view of one embodiment of the present invention showing a blade in a closed position.

FIG. 3 depicts a profile cutaway of one embodiment of the present invention wherein the levered blade actuator is shown with the blade in an open position.

FIG. 4 depicts a profile cutaway view of one embodiment of the present invention wherein the levered blade actuator is shown with the blade partially open.

FIG. 5 depicts a profile cutaway view of one embodiment of the present invention wherein the levered blade actuator is shown with the blade closed.

FIG. 6 depicts a profile cutaway of another embodiment of the present invention wherein the levered blade actuator is shown with the blade closed.

FIG. 7 depicts a profile cutaway of another embodiment of the present invention wherein the levered blade actuator is shown with the blade open.

FIG. 8 depicts a profile cutaway of yet another embodiment of the present invention wherein the levered blade actuator is shown with the blade closed.

FIG. 9 depicts a profile cutaway of yet another embodiment of the present invention wherein the levered blade actuator is shown with the blade partially open.

FIG. 10 depicts a profile cutaway of yet another embodiment of the present invention wherein the levered blade actuator is shown with the blade open.

### DETAILED DESCRIPTION

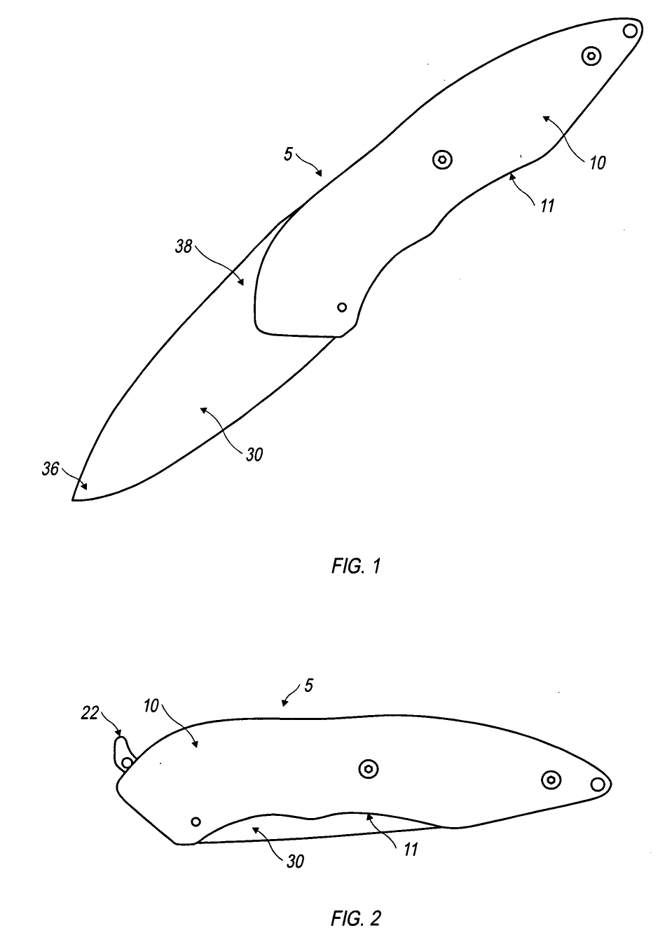

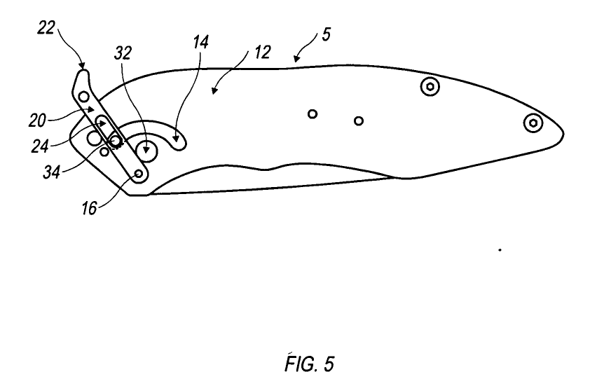

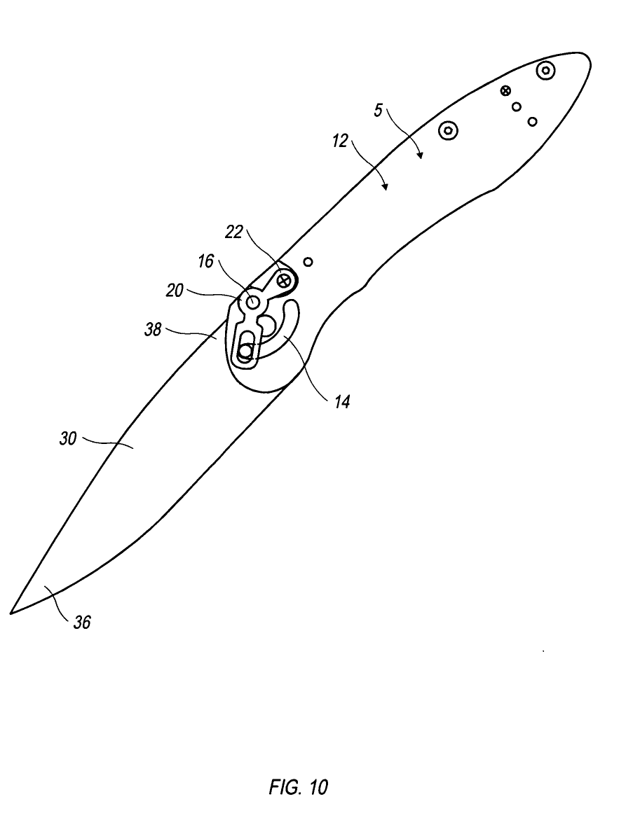

In each of the embodiments depicted in FIGS. 1-10 and described herein, a folding knife 5 includes a handle 10. A blade cavity 11 is formed in the handle 10 to substantially receive a blade 30. The blade 30 has a distal end 36 and a proximal end 38, with tang 35 located at the proximal end 38. The tang 35 is pivotally connected to handle 10 by a blade pivot 32. A blade actuator 20 is linked to the blade 30 by a blade pin 34 extending from the blade's tang 35 through an actuator groove 24 formed in the blade actuator 20. A digit tab 22 extends from an end region of the blade actuator 20 and beyond the handle 10 when the blade 30 is in a closed position. A user applies force to the digit tab 22 which causes the blade 30 to pivot about the blade pivot 32 from a closed position within the blade cavity 11 to an extended or open position by the linkage formed by blade pin 34 and actuator groove 24. Each of the embodiments further described below set forth various arrangements of the actuator 20, digit tab 22 and blade pin 34, as well as other details.

As shown in FIGS. 1-5, one embodiment of a folding knife 5 includes a handle 10 with at least one liner 12. A blade cavity 11 is formed in handle 10 to receive blade 30. The interior of the blade cavity 11 is shaped according to the form of the blade 30 and forms a housing for the blade 30 when the blade 30 is in the closed position. At least one liner 12 is located adjacent to blade cavity 11.

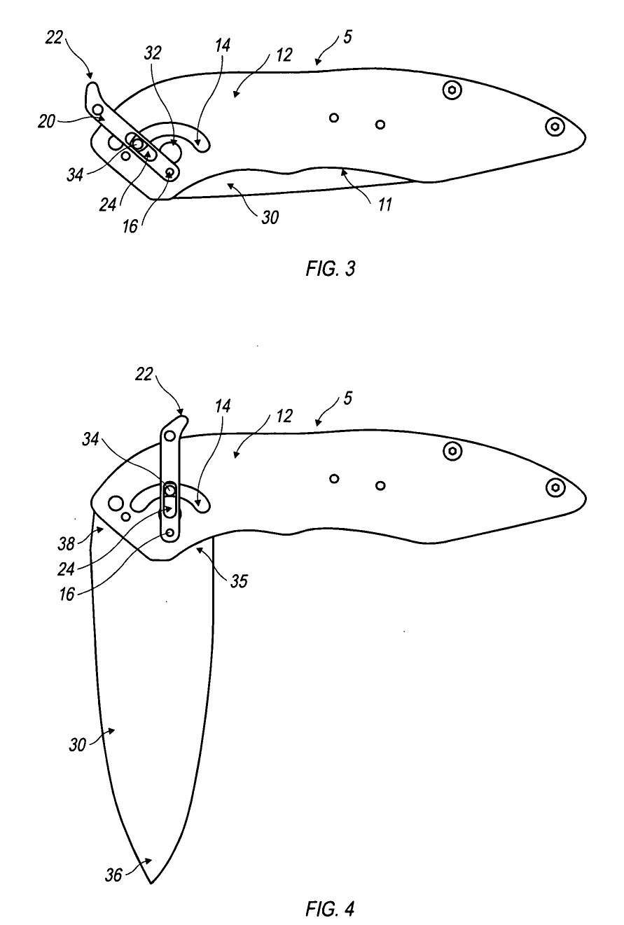

A primary groove 14 with an arcuate shape is formed in at least one liner 12 and at least partially surrounds blade pivot 32. See FIGS. 3-5. The primary groove 14 has an orientation in which the end regions of the primary groove are generally in line with a longitudinal axis of handle 10. An actuator pivot 16 extending from at least one liner 12 pivotally connects an actuator 20 to at least one liner 12. See FIGS. 3-5. A digit tab 22 extends from an end region of the actuator 20 and beyond the handle 10 when the blade 30 is in the closed position to allow a user to apply force upon the digit tab 22. The digit tab 22 is formed in the end region of the actuator 20 distal to the actuator pivot 16. See FIGS. 3-5.

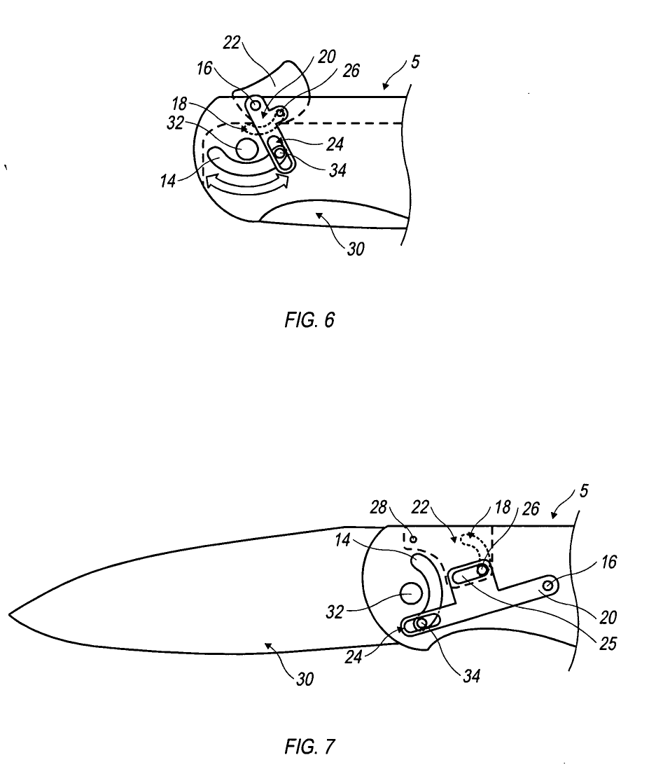

In another embodiment of the invention, as shown in FIG. 6, the handle 10, blade 30, blade cavity 11, at least one liner 12 and primary groove 14 are generally arranged in the same configuration as set forth in FIGS. 1-5. However, the mid-section of primary groove 14 is distal to digit tab 22 with blade pivot 32 positioned between the actuator pivot 16 and primary groove 14. See FIG. 6. Furthermore, digit tab 22 is positioned coplanar with the blade 30 and further coupled to an end region of the actuator 20 by the actuator pivot 16 and actuator pin 26. See FIG. 6. In such an arrangement, actuator pivot 16 extends towards and across the blade cavity 11 to couple the digit tab 22 to the actuator 20. The actuator pin 26 further couples the actuator 20 to digit tab 22 by extending between the two members through a secondary groove 18 formed in at least one liner 12. In other words, the actuator pin 26 extends from the digit tab 22 through a secondary groove 18 formed in at least one liner 12 to further couple the digit tab 22 to the actuator 20. By doing so, the digit tab 22 may also act as a stop to prevent extension of the blade 30 beyond the intended open position.

In another embodiment of the invention, as shown in FIG. 7, the handle 10, blade 30, blade cavity 11, at least one liner 12 and primary groove 14 are generally arranged in the same configuration as set forth in FIGS. 1-5. However, primary groove 14 is disposed between blade pivot 32 and actuator pivot 16. See FIG. 7. Furthermore, the orientation of primary groove 14 is such that one end region of primary groove 14 is proximal to digit tab 22 and the other end region of primary groove 14 is distal to digit tab 22. See FIG. 7. Similar to the embodiment shown in FIG. 6, digit tab 22 is coplanar with blade 30 and further pivotally coupled to at least one liner by digit tab pivot 28. Digit tab 22 is slideably coupled to actuator 20 by an actuator pin 26 projecting from the digit tab 22 through a secondary groove formed in the liner 12 and further extending through a secondary actuator groove 25 formed in the actuator 20. See FIG. 7. Like the embodiment depicted in FIG. 6, this embodiment may place digit tab 22 in a position with handle 10 to function as a stop to prevent extension of the blade 30 beyond the intended open position.

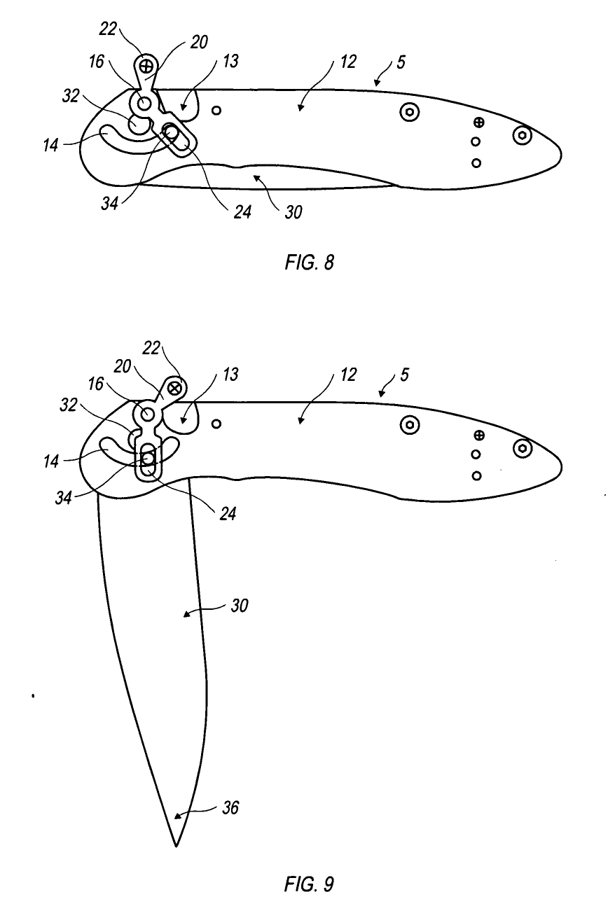

In yet another embodiment of the invention, as shown in FIGS. 8-10, the handle, blade 30, blade cavity 11, at least one liner 12 and primary groove 14 are generally arranged in the same configuration as set forth in FIGS. 1-5. However, blade pivot 32 is between actuator pivot 16 and actuator groove 24. See FIGS. 8-10. Similar to the embodiment shown in FIGS. 1-5, digit tab 22 extends from an end region of the actuator 20 beyond the handle 10 when the blade 30 is in a closed position to allow a user to apply force upon the digit tab 22. But unlike the actuator 20 and digit tab 22 configuration depicted in FIGS. 1-5, the digit tab 22 is located in the end region of the actuator 20 proximal to the actuator pivot 16. See FIGS. 8-10. In short, where the actuator groove 24 is disposed between the digit tab 22 and the actuator pivot 16 as depicted in FIGS. 1-5, this embodiment contemplates the actuator pivot 16 disposed between the digit tab 22 and actuator groove 24. See FIGS. 8-10. In such a configuration, actuator pivot 16 extends or projects from liner 12 to pivotally connect actuator 20 to the handle 10. In another variation, actuator pivot 16 further extends through cavity 11 to function as a stop whereby a portion of tang 35 makes contact with actuator pivot 16 to prevent blade 30 from over extending beyond the intended open position.

As shown in FIGS. 8-10, the digit tab 22 is located relatively close to the actuator pivot 16 such that the digit tab 22 requires only a small amount of displacement to rotate the blade 30 from the closed position to the open position. Furthermore, due to the linkage configuration, when the blade 30 is moved from the closed position to the open position, the actuator 20 rotates with respect to the handle 10 through an angle of rotation that is a fraction of an angle of rotation of the blade 30. For example, in the illustrated embodiment of FIGS. 8-10, as the blade 30 moves from the closed position to the open position, the actuator 20 rotates through about ninety (90) degrees while the blade 30 rotates through approximately one hundred eighty (180) degrees. In some embodiments, the angle of rotation of the actuator 20 is less than half of the angle of rotation of the blade 30. In this manner, a user can manually deploy the blade 30 safely from the closed position to the open position with only a slight movement of the user's hand. Furthermore, the user can manually open the blade 30 with ease without requiring assistance from a spring-biased opening mechanism or other assisted opening device.

As further shown in FIGS. 8-10, the digit tab 22 may extend substantially perpendicular to the longitudinal length of the knife 5 when in the blade is in the closed position. This enables the user to apply an opening force upon the digit tab 22 in a direction generally towards a back of the knife 5 in a comfortable and user-friendly manner. The applied force being transmitted via the actuator 20 to blade pin 34 to rotate the blade 30. As the blade 30 rotates towards the open position, the blade pin 34 may initially move away from actuator pivot 16 thereby increasing the effective lever arm of actuator 20 and reducing the amount of applied force needed to open the blade 30 further. Such a configuration is thus particularly suited for accelerating the blade 30 from the closed position to the open position.

In some embodiments, it is contemplated that the primary groove 14 and/or the actuator 20 is configured to allow the digit tab 22 to recede into a recess 13 formed in the handle 10 when the blade 30 is in the fully open position. In this manner, when the blade 30 is in the fully open position, the actuator 20 is substantially located within an outer perimeter of the handle 10. Accordingly, the actuator 20 is conveniently hidden within the handle 10 of the knife 5 when a user is operating the blade 30 in the open position.

The actuator groove 24 is shown in FIGS. 8-10 as being linear, with a longitudinal axis that, when extended, passes through the center of the actuator pivot 16. However, in some embodiments, the actuator groove 24 may vary in shape and orientation to modify the operational characteristics of the actuator 20. For example, in one embodiment, the actuator groove 24 may be curved, and in other embodiment, the actuator groove may include a jog or bend. In another embodiment, the actuator groove 24 may have an open end such that an end of the actuator 20 is fork-shaped.

In yet another embodiment, the actuator 20 does not include an actuator groove 24, but is instead positioned beside the blade pin 34 so that, when pressure is applied to the digit tab 22 by a user, the actuator 20 pushes the blade pin 34 and blade 30 toward the open position. A light spring (not shown) biases the actuator 20 so that digit tab 22 remains in a shallow recess 13 while the blade 30 is open.

In the embodiments of FIGS. 1-10, the actuator 20 is shown and described as being positioned on a side of the liner 12 opposite the blade 30. According to other embodiments, an actuator 20 is coupled to a surface of the liner 12 facing the blade 30, but in other respects operates substantially as described above. In still further embodiments, the handle 10 is a solid frame type handle, i.e., no liner 12 is employed, and an actuator 20 is coupled to a surface of the handle 10 facing the blade 30, to operate, again, substantially as described above.

It will be appreciated that a pivoting actuator 20 operatively coupled to a blade pin 34 or other projecting member 34 allows a knife designer the freedom to design the movement or throw of a digit tab 22 for a particular purpose without being limited to a blade's range or rate of motion about its pivot point, in contrast to conventional flipper folding knives in which the finger tab is integral to the blade. It is contemplated that this pivoting actuator provides novel solutions to blade movement of folding knives.

All of the U.S. patents, U.S. patent application publications, U.S. patent applications, foreign patents, foreign patent applications and non-patent publications referred to in this specification and/or listed in the Application Data Sheet, are incorporated herein by reference, in their entirety. Aspects of the embodiments can be modified, if necessary to employ concepts of the various patents, applications and publications to provide yet further embodiments.

It will be understood that certain features and sub-combinations are of utility and may be employed without reference to other features and sub-combinations. This is contemplated by and is within the scope of the claims. Since many possible embodiments of the invention may be made without departing from the scope thereof, it is to be understood that all matter herein set forth or shown in the accompanying drawings is to be interpreted as illustrative and not in a limiting sense.

What is claimed is:

1. A knife comprising:
a blade having a tang;
a handle having at least one liner;
a blade cavity formed in said handle adjacent to said at least one liner;
a primary groove formed in said at least one liner;
said tang pivotally connected to said handle by a blade pivot;
a blade pin extending from said tang and through said primary groove;
an actuator pivot projecting from said at least one liner to pivotally connect an actuator to said at least one liner;
a digit tab extending from an end region of said actuator and beyond said handle when the blade is in a closed position to allow a user to apply force upon said digit tab; and
an actuator groove formed in said actuator whereby said blade pin extends through said actuator groove to form an operative linkage to move said blade from a closed position to an open position when said force is applied upon said digit tab.

2. A knife as claimed in claim 1, wherein said digit tab is formed in said end region of said actuator distal to said actuator pivot.

3. A knife as claimed in claim 1, wherein said digit tab is formed in said end region of said actuator proximal to said actuator pivot.

4. A knife as claimed in claim 1, wherein said digit tab is positioned coplanar with said blade and coupled to an end region of said actuator distal to said blade pivot by said actuator pivot and an actuator pin, wherein said actuator pivot further extends towards and across said blade cavity to couple said digit tab with said actuator and said actuator pin extends from said digit tab through a secondary groove formed in said at least one liner to further couple said digit tab with said actuator.

5. A knife as claimed in claim 1, wherein said digit tab is positioned coplanar with said blade and pivotally coupled to said at least one liner by said digit tab pivot and coupled to said actuator by an actuator pin extending through a secondary groove formed in said at least one liner and further extending through a secondary actuator groove formed in said actuator.

6. A knife as claimed in claim 1, wherein the primary groove is configured to enable said digit tab to recede into a recess formed in said at least one liner when said blade is fully open.

7. A folding knife comprising:
a handle;
a blade cavity formed in said handle;
a blade pivotally coupled to said handle by a blade pivot to allow said blade to pivotally move in and out of said blade cavity;
an actuator pivotally coupled to said handle by an actuator pivot and slideably coupled to said blade by a blade pin extending through a primary arcuate groove formed in said handle and further extending through an actuator groove formed in said actuator to form a operative linkage to allow said pivotal movement of said blade; and
a digit tab coupled to said actuator to allow a user to apply force to said actuator to pivotally move said blade from said closed position to said open position.

8. A folding knife as claimed in claim 7, wherein said blade pivot is positioned in said handle between said primary groove and said actuator pivot.

9. A folding knife as claimed in claim 8, wherein said digit tab is coupled to said actuator by an actuator pin extending from said digit tab through a secondary groove formed in said handle and further pivotally coupled to said handle by said actuator pivot.

10. A folding knife as claimed in claim 8, wherein said digit tab is coupled to an end region of said actuator distal to said actuator groove.

11. A folding knife as claimed in claim 7, wherein said primary groove is between said blade pivot and said actuator pivot.

12. A folding knife as claimed in claim 7, wherein the primary groove is configured to enable said digit tab to recede into a recess formed in said handle when said blade is fully open.

13. A folding knife comprising:
a handle;
a blade pivot extending transversely through one end of said handle;
a blade having a tang pivotally coupled to said handle by said blade pivot and configured to move between a closed position, in which said blade is substantially received inside said handle, and an open position, in which said blade extends from said one end of said handle;
a blade pin extending outward from said tang;
an actuator coupled to said handle by an actuator pivot and further slideably coupled to said blade by an actuator groove formed in said actuator; and
a digit tab coupled to said actuator to allow a user to apply force to said actuator to pivotally move said blade from said closed position.

14. A folding knife as claimed in claim 13, wherein said actuator pivot is distal to said digit tab.

15. A folding knife as claimed in claim 13, wherein said actuator pivot is proximal to said digit tab.

16. A folding knife as claimed in claim 13, wherein said actuator pivot is generally in line with a longitudinal axis of said handle.

17. A folding knife comprising:
a handle with at least one liner;
a blade cavity formed in said handle adjacent to said at least one liner;
a blade with a tang pivotally connected to said handle by a blade pivot to allow said blade to move between a closed position, in which said blade is substantially received inside said blade cavity, and an open position, in which said blade extends from said handle;
an actuator with a midsection disposed between a first end and a second end, wherein said first end is pivotally coupled to said at least one liner, a digit tab extends from said second end and an actuator groove is formed in said midsection; and
a blade pin extending from said tang through a primary groove formed in said at least one liner and further through said actuator groove.

18. A folding knife comprising:
a handle with at least one liner;
a blade cavity formed in said handle adjacent to said at least one liner;
a blade with a tang pivotally connected to said handle by a blade pivot to allow said blade to move between a closed position, in which said blade is substantially received inside said blade cavity, and an open position, in which said blade extends from said handle;
an actuator with a midsection disposed between a first end and a second end, wherein an actuator groove is formed in said first end, a digit tab extends from said second end and said actuator is pivotally coupled to said at least one liner at said midsection; and
a blade pin extending from said tang through a primary groove formed in said at least one liner and further through said actuator groove.

19. A folding knife comprising:
a handle having a blade cavity;
a blade pivotally coupled to said handle and configured to move between a closed position, in which said blade is substantially received in said blade cavity, and an open position, in which said blade extends from said handle; and
an actuator pivotally coupled to said handle and movably coupled to said blade, a portion of said actuator extending beyond said handle when said blade is in said closed position to allow a user to apply force to said actuator to move said blade to said open position.

20. A folding knife as claimed in claim 19, wherein said actuator is configured such that, when said blade is moved from said closed position to said open position, an angle of rotation of said actuator with respect to said handle is a fraction of an angle of rotation of said blade with respect to said handle.

21. A folding knife as claimed in claim 19, wherein said portion of said actuator is configured to recede into a recess of said handle when said blade is moved to said open position so that said actuator is substantially located within an outer perimeter of said handle when said blade is in said open position.
